(19) United States
(12) Patent Application Publication
(10) Pub. No.: US 2015/0027994 A1
(43) Pub. Date: Jan. 29, 2015

(54) FLUX SHEET FOR LASER PROCESSING OF METAL COMPONENTS

(71) Applicant: SIEMENS ENERGY, INC., ORLANDO, FL (US)

(72) Inventors: Gerald J. Bruck, Oviedo, FL (US); Ahmed Kamel, Orlando, FL (US); Atul L. Navale, Houston, TX (US); Ivan F. Oliver Vargas, Houston, TX (US)

(21) Appl. No.: 14/507,935

(22) Filed: Oct. 7, 2014

Related U.S. Application Data
(63) Continuation-in-part of application No. 14/341,888, filed on Jul. 28, 2014.
(60) Provisional application No. 61/859,317, filed on Jul. 29, 2013.

(51) Int. Cl. B23K 35/34; B23K 35/02; B23K 35/362; B23K 26/32; B23K 25/00

(52) U.S. Cl. CPC B23K 35/34; B23K 26/3206; B23K 25/005; B23K 35/362; B23K 35/0233
USPC 219/73.21; 442/414; 219/73; 148/26

(57) ABSTRACT

A flux sheet (20A) and method of using the flux sheet to restore a surface (24) of a metal substrate (26). A laser beam (32) is directed onto the flux sheet to melt it and the surface, then allowed to cool and solidify to produce a restored surface. The flux sheet may be formulated to optically transmit at least 40% of electromagnetic energy from a laser onto the substrate surface. The flux sheet contains a flux composition that may include: a metal oxide, a metal silicate, or both; a metal fluoride; and a metal carbonate. The flux composition may limit the content of certain elements and compounds such as Fe, Li₂O, Na₂O and K₂O. The flux composition may include constituents providing air shielding, contaminant scavenging, viscosity/fluidity enhancement, and optical transmission of laser energy through the flux sheet.

This application is a continuation-in-part of U.S. patent application Ser. No. 14/341,888 filed 28 Jul. 2014 (attorney docket number 2013P12177US01), which claims benefit of U.S. provisional application No. 61/859,317 filed on 29 Jul. 2013 (attorney Docket No. 2013P12177US), both of which are incorporated herein by reference in their entireties.

### FIELD OF THE INVENTION

This invention relates generally to the field of materials technology, and more particularly to laser processing of metal surfaces, and specifically to flux sheets for use during laser processing of high-temperature superalloy components.

### BACKGROUND OF THE INVENTION

Superalloy components such as gas turbine blades can develop operational defects including cracks and surface wear. Often such wear is repairable by removal of some volume of defective material and filling the removed volume with replacement metal using cladding techniques. However, airfoils and other complex shapes are difficult to clad because the repair requires controlling the delivery of process energy and filler material onto a three-dimensional curved surface. Advanced laser scanning optics, such as galvanometer driven mirrors and other optical tools, can rapidly scan a laser beam in three dimensions. However, delivering the cladding filler material in three dimensions is difficult. Feeding of filler or flux in the form of powder is inefficient. Even flat horizontal surfaces allow particulate scattering losses on the order of 40%. Surfaces inclined to the powder delivery direction cause even higher powder scattering losses. Filler material may be delivered by feeding a solid wire to such inclined surfaces. However, the wire tip position must be precisely coordinated with the laser beam spot. A laser beam can move much more rapidly and precisely than a wire tip (e.g. 3 meter per second versus 0.03 meter per second), so the use of wire slows processing and reduces precision.

Superalloy materials are among the most difficult materials to fabricate and repair due to their susceptibility to melt solidification cracking and strain age cracking. The term “superalloy” is used herein as it is commonly used in the art—a highly corrosion and oxidation resistant alloy with excellent mechanical strength and resistance to creep at high temperatures. Superalloys typically include high nickel or cobalt content. Examples of superalloys include alloys sold under the trademarks and brand names Hastelloy, Inconel alloys (e.g. IN 738, IN 792, IN 939), Rene alloys (e.g. Rene N5, Rene 41, Rene 80, Rene 108, Rene 142, Rene 220), Haynes alloys (282), Mar M, CM 247, CM 247 LC, C263, 718, X-750, ECY 768, X45, PWA 1480, PWA 1483, PWA 1484, CMSX single crystal alloys (e.g., CMSX-4, CMSX-8, CMSX-10), GTD 111, GTD 222, MGA 1400, MGA 2400, PSM 116, IN 713C, Mar-M-200, IN 100, IN 700, Udimet 600, Udimet 500 and titanium aluminide. The term “metal” as used herein is meant to include pure metals as well as alloys of metal.

FIG. 1 is a chart illustrating the relative weldability of various alloys as a function of their aluminum and titanium content. Alloys such as Inconel® 718 which have relatively lower concentrations of these elements, and consequentially relatively lower gamma prime content, are considered relatively weldable. Alloys such as Inconel® 939 which have relatively higher concentrations of these elements are generally considered to be difficult to weld and require special procedures which minimize the heat input of the process. For purposes of discussion herein, the dashed line 20 indicates a border between a zone of weldability below the line 20 and a zone of non-weldability above the line 20. The line 20 intersects 3 wt % aluminum on the vertical axis and 6 wt % titanium on the horizontal axis. Within the zone of non-weldability, the alloys with the highest aluminum content are generally found to be the most difficult to weld.

There is a challenge to develop commercially feasible repair and joining processes for superalloy materials. Powder sizes used in typical powder based processes are shown in FIG. 2 for plasma spray, high velocity oxygen fuel spray (HVOF), low pressure plasma spray (LPPS), cold gas spray, selective laser melting (SLM), combustion spray, plasma transferred arc spray, and laser cladding. The usable powder size distribution differs with process, and constitutes a limitation on each of these processes in terms of powder feeding mass delivery rate and efficiency of powder usage. A disadvantage of loose powder used as a metal filler and/or flux feed material for laser processing is that it can scatter when fed or placed in a bed ahead of a laser beam, and it can slide or shift on non-horizontal surfaces.

### BRIEF DESCRIPTION OF THE DRAWINGS

The invention is explained in the following description in view of the drawings that show:

FIG. 1 illustrates relative weldability of various superalloys.

FIG. 2 illustrates ranges of particle sizes for existing additive processes.

FIG. 3 is a perspective view of a fabric flux sheet.

FIG. 4 is a sectional view of a flux sheet placed over defects on a substrate.

FIG. 5 illustrates an apparatus and process of restoring the substrate of FIG. 4.

FIG. 6 illustrates forming a flux sheet on a surface by applying a liquefied film of a flux composition.

FIG. 7 illustrates an apparatus and process of restoring a surface with flux tape fed from a roll.

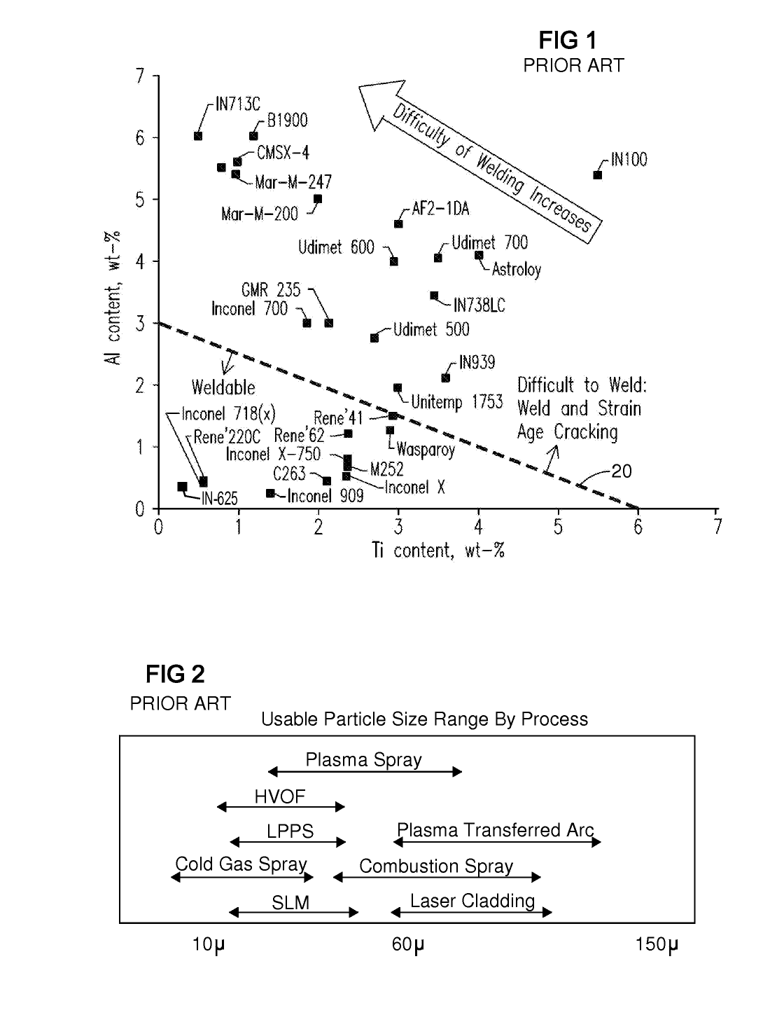

### DETAILED DESCRIPTION OF THE INVENTION

The inventors have developed a conformable flux sheet, meaning a coherent and flexible sheet or film made of flux, and a process of melting metal surfaces together with the flux sheet for repair and joining thereof. The sheet is placed over a metal surface, and a laser beam is directed onto the sheet. The flux provides beam energy transmission and selective trapping, impurity cleansing, atmospheric shielding, melt surface shaping, melt cooling control, and optional alloy rebalancing, providing crack-free joining and repair of superalloy and other substrate materials without the need for high temperature hot box welding or the use of a chill plate, inert shielding gas, or vacuum environment. The flux sheet may be attached or adhered to curved and non-horizontal surfaces.

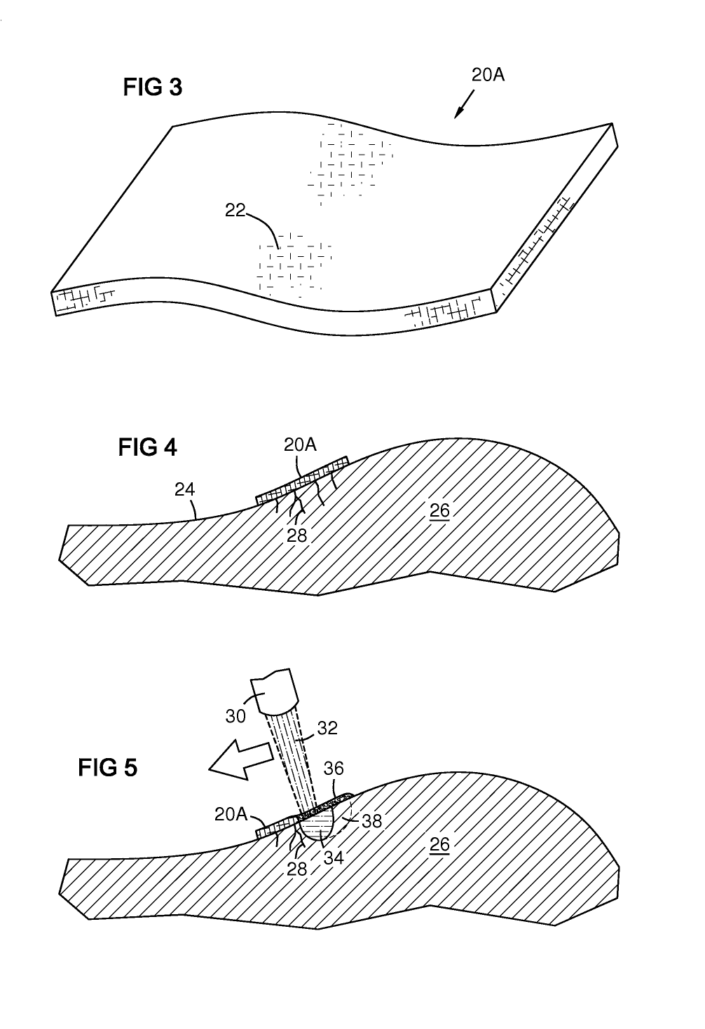

FIG. 3 is a perspective view of a flux sheet 20A embodied as a fabric containing fibers 22 of flux compositions described herein and in the parent application. The fabric may be woven or non-woven. In non-woven form, the flux fibers may be fixed in a desired shape for example by spark plasma sintering in a mold. The degree of sintering may be limited to preserve flexibility and a predetermined void fraction. For example, the resulting sheet may have a void fraction of at least 40%, allowing laser energy to penetrate between the fibers. Alternately, non-woven fibers may be formed into a sheet by using a binder such as a polymer, latex, vermiculite, or ceramic cements such as phosphate, silicate (e.g., ethyl silicate), and magnesium oxysulfate to bind the fibers sufficiently to hold a shape. A predetermined void fraction such as at least 40% void fraction may be provided in the resulting sheet. The sheet thickness may be uniform or it may be contoured to fit a surface. A woven or non-woven sheet may be formed as a tape that can be fed from a roll ahead of laser processing on a surface.

FIG. 4 shows a surface 24 on a substrate 26 of an article such as a superalloy turbine component with defects 28 such as cracks. A flux sheet 20A is placed on the surface 24 over the defects. The sheet may be adhered to the surface with an adhesive such as zirconia silica adhesive or alumina silica adhesive, which are commercially available. Alternately, the sheet may be held in place by mechanical means such as silica thread or rope, also commercially available.

FIG. 5 shows laser processing with a laser emitter 30 that directs a laser beam 32 onto the flux sheet 20A over the surface defect 28. This re-melts a portion of the substrate surface, forming a melt pool 34 to a depth of the defect or at least to a depth sufficient to seal the defect. A slag blanket 36 covers the melt pool and a solidified repair volume 38. The slag blanket 36 shields the melt pool 34 and the solidified, but still hot, repair volume 38 from the atmosphere, without the need for expensive inert gas. The flux may transmit the laser energy to facilitate heating of the underlying substrate. It also provides energy absorption and trapping to effectively convert the laser beam into heat energy, thus facilitating a precise control of heat input. It provides a laser greenhouse effect that increases the melt depth for a given laser intensity. It provides thermal insulation that causes the melt pool 34 and the solidified material 38 to cool slowly and evenly, reducing residual stresses. An important further flux function is to clean the melt pool of trace impurities such as sulfur and phosphorous that contribute to solidification cracking. Cleansing may include deoxidation of oxidized substrate surfaces by scavenging and floating oxidized surface material such as alumina into the removable slag blanket 36. Materials that facilitate the above functions of this paragraph will be called flux compositions herein. The flux sheet 20A may be constituted primarily or totally of flux constituents, for example alumina, silica, and/or zirconia, which provide the above functions.

Flux materials of the present disclosure may be formulated to contain at least one of the following components: (i) an optically transmissive vehicle; (ii) a viscosity/fluidity enhancer; (iii) a shielding agent; (iv) a scavenging agent; and (v) a vectoring agent.

Optically transmissive constituents include metal oxides, metal salts and metal silicates such as alumina (Al₂O₃), silica (SiO₂), zirconium oxide (ZrO₂), sodium silicate (Na₂SiO₃), potassium silicate (K₂SiO₃), and other compounds capable of optically transmitting laser energy (e.g., as generated from NdYAG and Yt fiber lasers). Viscosity/fluidity enhancers include metal fluorides such as calcium fluoride (CaF₂), cryolite (Na₃AlF₆) and other agents known to enhance viscosity and/or fluidity (e.g., reduced viscosity with CaO, MgO, Na₂O, K₂O and increasing viscosity with Al₂O₃ and TiO₂) in welding applications. Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂). Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂) and other agents known to react with detrimental elements such as sulfur and phosphorous to form low-density byproducts expected to “float” into a resulting slag layer. Vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements.

In some embodiments flux materials of the present disclosure may include:

5-60% by weight of at least one optically transmissive vehicle;

10-70% by weight of at least one viscosity/fluidity enhancer;

0-40% by weight of at least one shielding agent;

5-30% by weight of at least one scavenging agent; and

0-7% by weight of at least one vectoring agent, relative to a total weight of the flux composition.

For example, in some embodiments flux materials of the present disclosure can include:

5-60% by weight of at least one metal oxide;

10-70% by weight of at least one metal fluoride;

5-40% by weight of at least one metal silicate; and

0-40% by weight of at least one metal carbonate, relative to a total weight of the flux composition.

For instance, some flux materials of the present disclosure are formulated to include:

5-60% by weight of at least one of Al₂O₃, SiO₂, Na₂SiO₃ and K₂SiO₃;

10-50% by weight of at least one of CaF₂, Na₃AlF₆, Na₂O and K₂O;

1-30% by weight of at least one of CaCO₃, Al₂(CO₃)₃, NaAl(CO₃)(OH)₂, CaMg(CO₃)₂, MgCO₃, MnCO₃, CoCO₃, NiCO₃ and La₂(CO3)₃;

15-30% by weight of at least one of CaO, MgO, MnO, ZrO₂ and TiO₂; and

0-5% by weight of at least one of Ti, Al and CaTiSiO₅.

All of the percentages (%) by weight enumerated above and throughout the present disclosure are based upon a total weight of the flux material being 100%.

Certain naturally-occurring minerals may also be employed within a flux sheet. One beneficial naturally-occurring flux composition is basalt, which is a fine-grained igneous rock. In one embodiment, basalt fibers may compose at least 25 wt % of the flux sheet. Basalt generally has a composition of 45-55 wt % SiO₂, 2-6 wt % total alkalis, 0.5-2.0 wt % TiO₂, 5-14 wt % FeO, 14-19 wt % Al₂O₃, 8-12 wt % CaO, and 5-12 wt % MgO. It has less than 20% quartz and less than 10% feldspar by volume, with at least 65% of the feldspar is in the form of plagioclase. A beneficial form of basalt in one embodiment of the invention is fibers. Basalt may be formed into fibers as described in non-patent publication: “Basalt Fibers: Alternative to Glass?” by Anne Ross, published 2006-08-01, by Composites Technology, Wheat Ridge, Colo., USA.

Optionally, the flux sheet may further contain alloy rebalancing vectors (vectoring agents) that compensate for loss of elements in the substrate that are volatized or reacted during processing or have been operationally reduced. The refreshed surface may match its original composition or it may be further enriched with certain constituents to provide improved performance when compared to the original material composition. For example, aluminum is operationally reduced in superalloy turbine components by diffusion to the surface and oxidization thereon. Titanium can also be operationally reduced. These reductions age the substrate and contribute to surface degradations. To restore such alloy constituents at the surface, the flux sheet may include rebalancing vectors in addition to flux compositions. Such vectors may provide for example 1-3 wt % or 1-5 wt % of aluminum by additions such as Al₂(CO₃)₂, NaAlCO₃(OH)₂, and/or elemental Al. Rebalancing vectors may alternately or additionally provide 1-3 wt % or 1-5 wt % titanium. Other superalloy constituents such as nickel, cobalt, and iron are operationally stable or are otherwise unneeded and unwanted in the flux sheet. Accordingly the flux sheet may contain less than 0.5% each of Ni, Co, and Fe.

In some embodiments the flux composition is formulated to exclude certain compounds that tend to form optical plasmas when exposed to laser energy. For example, metal oxide compounds such as Li₂O, Na₂O, and K₂O may be excluded. Such compounds are often not well suited to flux materials of the present disclosure, because optical plasmas can prevent the laser energy from being absorbed and transferred to the process location. In other embodiments the flux composition may include one or more plasma-generating compounds.

In some embodiments, the flux composition comprises: 5-85 wt % of a metal oxide, a metal silicate, or both; 10-70 wt % of a metal fluoride; and 1-30 wt % of a metal carbonate, relative to a total weight of the flux composition. The flux sheet may contain less than 0.5 wt % each of Fe, Li₂O, Na₂O and K₂O.

In another embodiment, the flux composition comprises:

a) 5-25 wt % of one or more shielding agent selected from CaCO₃, Al₂(CO₃)₃, NaAl(CO₃)(OH)₂, CaMg(CO₃)₂, MgCO₃, MnCO₃, CoCO₃, and NiCO₃;

b) 10-25 wt % of one or more scavenging agent selected from CaO, FeO, MgO, MnO, MnO₂, NbO, NbO₂, Nb₂O₅, and ZrO₂;

c) 15-35 wt % of one or more viscosity/fluidity enhancer selected from CaF₂, Na₃AlF₆ and TiO₂; and

d) 20-40 wt % of one or more optically transmissive constituent selected from

Al₂O₃, SiO₂, ZrO₂, Na₂SiO₃, and K₂SiO₃.

In another embodiment, the flux composition comprises:

5-82 wt % of one or both of a metal silicate and a metal oxide other than zirconia;

7-25 wt % of zirconia;

10-70 wt % of a metal fluoride; and

1-30 wt % of a metal carbonate,

wherein the flux composition comprises less than 0.5 wt % of each of Fe, Li₂O, Na₂O, and K₂O.

As above, all weight percentages are relative to a total weight of the flux composition.

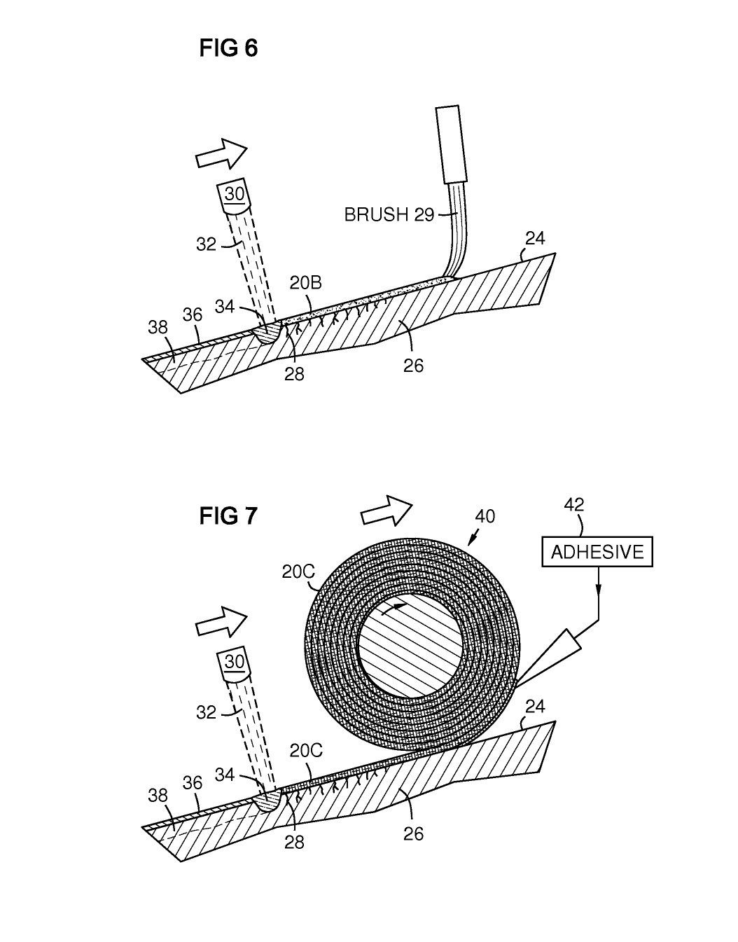

FIG. 6 illustrates a flux sheet 20B being formed on a surface 24 by applying the flux composition in liquid form with a brush 29. A powder and/or fibers of the flux composition may be mixed with a liquid such as water or acetone, and sprayed or brushed onto and into the defects 28 to be repaired. The liquid may contain a binder such as a zirconia silica adhesive or an alumina silica adhesive that holds the flux on the surface, where it forms the sheet. The liquid may be allowed to evaporate or may be evaporated by infrared heating or low intensity laser heating before laser melting. Preferably the resulting sheet 20B is at least 40% optically transmissive to admit the laser energy, meaning at least 40% of the laser electromagnetic energy passes through the sheet before conversion to heat. This can be provided with at least a 40% void fraction after drying and/or by at least 40 wt % optically transmissive constituents in the sheet, such as Al₂O₃, SiO₂, ZrO₂, Na₂SiO₃, and K₂SiO₃. The laser beam 32 re-melts the surface 24 of the substrate 26, forming a melt pool 34 to a depth of the defect 28 or at least to a depth sufficient to seal the defect. A slag blanket 36 covers the melt pool and the solidified repair volume 38. This shields the melt pool 34 and the solidified, but still hot, repair volume 38 from the atmosphere, without the need for expensive inert gas.

FIG. 7 illustrates restoration of a surface 24 with a laser emitter 30 directing a laser beam 32 onto a flux sheet formed as a tape 20C, and fed from a roll 40 over the surface. Adhesive 42 may be applied to the tape 20C as shown or during fabrication of the tape or during assembly of the roll 40. Alternately, adhesive may be applied to the surface 24 or the tape may be held against the surface by attachment means such as ties or rollers. The laser beam 32 re-melts the substrate, forming a melt pool 34 to a depth of a defect 28 or at least to a depth sufficient to seal the defect. A slag blanket 36 covers the melt pool and a solidified repair volume 38. This shields the melt pool 34 and the solidified, but still hot, repair volume 38 from the atmosphere, without the need for expensive inert gas.

A repair process for superalloy components in accordance with embodiments of the invention may include preliminary cleaning of a degraded surface without the need for grinding. A conformal flux sheet is placed on the surface, and a laser beam is then traversed across the flux sheet to re-melt the surface. This heals surface defects, leaving a renewed surface after removal of the slag by known mechanical and/or chemical processes. It provides the following advantages:

a) Can restore existing 3-D surfaces. Not limited to horizontal flat surfaces.

b) No scattering of powder.

c) Usable for a wide range of metals that are difficult to weld.

d) Robust process that is adaptable to new damage modes.

e) No pre-heating or fast cooling needed.

f) Improved shielding that extends over the melt and the hot metal without the need for inert gas. No shielding of the melt pool by inert gas is needed.

g) Flux cleansing and scavenging of constituents that otherwise lead to solidification cracking.

h) Flux enhanced laser beam absorption and minimal reflection back to processing equipment.

i) Optional addition of alloying elements including powders, filaments and foils of the superalloy itself to refresh/improve and rebuild the material surface. In addition to metallic alloy additions, such filaments and foils (e.g. foil backing), may further serve to strengthen the flux sheet and to provide alternate surface to adhere to substrates.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A flux sheet comprising a flux composition comprising:
5-85 percent by weight of a metal oxide, a metal silicate, or both;
10-70 percent by weight of a metal fluoride; and
1-30 percent by weight of a metal carbonate,
wherein the flux sheet contains less than 0.5 percent by weight of each of Fe, Li₂O, Na₂O and K₂O,
relative to a total weight of the flux composition.

2. The flux sheet of claim 1, wherein the flux composition comprises:
greater than 50 percent by weight of one or more of alumina, silica, and zirconia; and
less than 0.5 percent by weight of each of nickel and cobalt.

3. The flux sheet of claim 1, wherein the flux composition further comprises:
1-3 wt % of aluminum provided by one or more of Al₂(CO₃)₂, NaAlCO₃(OH)₂ and elemental aluminum; and
1-3 wt % titanium provided by one or more of TiO₂, CaTiSiO₅ and elemental titanium.

4. The flux sheet of claim 1, wherein the flux composition is in the form of fibers.

5. The flux sheet of claim 4, wherein at least 25 percent by weight of the flux sheet is constituted of basalt fibers, relative to a total weight of the flux sheet.

6. The flux sheet of claim 1, wherein the flux composition is in the form of a non-woven fabric having a void fraction of at least 40% by volume, relative to a total volume of the non-woven fabric.

7. The flux sheet of claim 1, formed from a liquid film on a substrate surface, wherein the liquid film comprises a powder or fibers of the flux composition mixed with a liquid comprising a zirconia silica adhesive or an alumina silica adhesive that adheres the flux sheet to the substrate surface.

8. The flux sheet of claim 7, wherein:
the flux sheet satisfies at least one of the following requirements
a) has a void fraction of at least 40% by volume, relative to a total volume of the flux sheet, and
b) comprises at least one selected from the group consisting of Al₂O₃, SiO₂, ZrO₂, Na₂SiO₃ and K₂SiO₃; and
the flux sheet transmits at least 40% of electromagnetic energy from a laser beam applied to a surface of the flux sheet.

9. The flux sheet of claim 1, wherein the flux composition comprises:
7-25 percent by weight of zirconia;
5-82 percent by weight of one or both of the metal silicate and a metal oxide other than the zirconia;
10-70 percent by weight of the metal fluoride; and
1-30 percent by weight of the metal carbonate, relative to the total weight of the flux composition.

10. The flux sheet of claim 1, wherein the flux sheet contains less than 0.5 percent by weight of each of Ni and Co.

11. A flux sheet comprising a flux composition comprising:
a) 5-25 percent by weight of at least one selected from the group consisting of CaCO₃, Al₂(CO₃)₃, NaAl(CO₃)(OH)₂, CaMg(CO₃)₂, MgCO₃, MnCO₃, CoCO₃ and NiCO₃;
b) 10-25 percent by weight of at least one selected from the group consisting of CaO, FeO, MgO, MnO, MnO₂, NbO, NbO₂ and Nb₂O₅;
c) 15-35 percent by weight of at least one selected from the group consisting of CaF₂, Na₃AlF₆, Na₂O, K₂O, and TiO₂; and
d) 20-40 percent by weight of at least one selected from the group consisting of Al₂O₃, SiO₂, ZrO₂, Na₂SiO₃ and K₂SiO₃, relative to a total weight of the flux composition.

12. The flux sheet of claim 11, wherein the flux composition comprises one or both of:
e) 1-3 weight percent of aluminum provided by one or more of Al₂(CO₃)₂, NaAlCO₃(OH)₂ and elemental aluminum; and
f) 1-3 weight percent of titanium provided by one or more of TiO₂, CaTiSiO₄ and elemental titanium.

13. The flux sheet of claim 11, wherein the flux composition contains less than 0.5 weight percent each of Fe, Li₂O, Na₂O, and K₂O.

14. The flux sheet of claim 11, wherein the flux composition contains less than 0.5 weight percent of each of Ni and Co.

15. The flux sheet of claim 11, wherein the flux composition comprises at least two selected from the group consisting of Al₂O₃, SiO₂, ZrO₂, Na₂SiO₃, and K₂SiO₃.

16. The flux sheet of claim 11, wherein the flux sheet is at least 40% optically transmissive to an electromagnetic laser energy.

17. A method utilizing a flux sheet according to claim 1, the method comprising:
disposing a flux sheet according to claim 1 on a metal substrate;
directing a laser beam onto the flux sheet to melt the flux sheet and an underlying surface of the metal substrate; and
allowing the melted surface to cool and to solidify to produce a restored surface.

18. The method of claim 17, wherein the flux composition comprises at least one of:
1-3 weight percent of aluminum provided by one or more of Al₂(CO₃)₂, NaAlCO₃(OH)₂ and elemental aluminum; and
1-3 weight percent of titanium provided by one or more of TiO₂, CaTiSiO₄ and elemental titanium.

19. The method of claim 17, wherein the flux composition comprises at least 7.5 percent by weight of zirconia.

20. The method of claim 19, further comprising forming the flux sheet by applying a liquid film onto a surface of the metal substrate, wherein the liquid film comprises a powder or fibers of the flux composition mixed with a liquid containing a zirconia silica adhesive or an alumina silica adhesive that adheres the flux sheet to the surface of the metal substrate.
